(19) United States
(12) Patent Application Publication
(10) Pub. No.: US 2022/0220396 A1
(43) Pub. Date: Jul. 14, 2022

(54) SYSTEMS AND PROCESSES FOR HYDROCARBON UPGRADING

(71) Applicant: Saudi Arabian Oil Company, Dhahran (SA)

(72) Inventors: Ki-Hyouk Choi, Dhahran (SA); Mazin M. Fathi, Dhahran (SA)

(73) Assignee: Saudi Arabian Oil Company, Dhahran (SA)

(21) Appl. No.: 17/142,746

(22) Filed: Jan. 6, 2021

(51) Int. Cl. C10G 55/04; C10G 31/08; C10G 49/18; C10G 33/06; C10G 7/00

(52) U.S. Cl. CPC C10G 55/04; C10G 31/08; C10G 49/18; C10G 33/06; C10G 2300/805; C10G 2300/1037; C10G 2300/4006; C10G 2300/4012; C10G 7/00

(57) ABSTRACT

A process for upgrading a hydrocarbon-based composition that includes combining a supercritical water stream with a pressurized, heated hydrocarbon-based composition in a mixing device to create a combined feed stream. The combined feed stream is introduced into a supercritical upgrading reactor to at least partially convert the combined feed stream to an upgraded product. The process includes separating the upgraded product to produce a light fraction and a heavy fraction, and separating the light fraction in the gas/oil/water separator to produce a gas fraction, a liquid oil fraction, and a first water fraction; combining the heavy fraction with at least a portion of one of the liquid oil fraction or the first water fraction to form a diluted heavy fraction; and passing the diluted heavy fraction from the flash drum to a demulsifier mixer to form a demulsified heavy fraction.

### TECHNICAL FIELD

Embodiments of the present disclosure generally relate to upgrading petroleum-based compositions, and more specifically relate to supercritical reactor systems, methods, and uses for upgrading petroleum-based compositions.

### BACKGROUND

Petroleum is an indispensable source of energy; however, most petroleum is heavy or sour petroleum, meaning that it contains a high amount of impurities (including sulfur and coke, a high carbon petroleum residue). Heavy petroleum must be upgraded before it is a commercially valuable product, such as fuel. Supercritical water has been known to be an effective reaction medium for heavy oil upgrading without external supply of hydrogen. Although supercritical water process has superior performance to conventional thermal refining process, it is important to achieve maximum efficiency when upgrading by separating as much water from upgraded hydrocarbons as possible, to increase recovery yield. However, conventional oil-water separation processes typically result in greater than 3 weight percent of original feedstock lost to water separation, meaning that the separated water product includes greater than 3 weight percent upgraded hydrocarbons by weight of the original feedstock hydrocarbons. Additionally, there is inherent difficulty in separating water from hydrocarbons in conventional processes, due to the tight water/oil emulsion.

### SUMMARY

Accordingly, a need exists for a process for more efficient water separation from upgraded hydrocarbon product in supercritical water hydrocarbon upgrading processes. The present disclosure addresses this need by introducing the upgraded hydrocarbons to a flash drum to produce a light fraction and a heavy fraction, and then introducing the heavy fraction to a demulsifier mixer. This differs from conventional processes that introduce the upgraded hydrocarbons to a demulsifier mixer without passing a flash drum. Additionally, the present disclosure addresses the need for more efficient water separation by introducing a cutterstock fraction including at least a portion of the light fraction to the heavy fraction either before or after the heavy fraction is introduced to the demulsifier mixer.

In accordance with one embodiment of the present disclosure, a process for upgrading a hydrocarbon-based composition is provided. The process involves combining a supercritical water stream with a pressurized, heated hydrocarbon-based composition in a mixing device to create a combined feed stream; introducing the combined feed stream into a supercritical upgrading reactor operating at a temperature greater than a critical temperature of water and a pressure greater than a critical pressure of water; at least partially converting the combined feed stream to an upgraded product; passing the upgraded product out of the supercritical upgrading reactor to a flash drum; separating the upgraded product in the flash drum to produce a light fraction and a heavy fraction; passing the light fraction to a gas/oil/water separator; separating the light fraction in the gas/oil/water separator to produce a gas fraction, a liquid oil fraction, and a first water fraction; combining the heavy fraction with at least a portion of one of the liquid oil fraction or the first water fraction with to form a diluted heavy fraction; and passing the diluted heavy fraction from the flash drum to a demulsifier mixer to form a demulsified heavy fraction.

In another embodiment of the present disclosure, another process for upgrading a hydrocarbon-based composition is provided. The process comprises combining a supercritical water stream with a pressurized, heated hydrocarbon-based composition in a mixing device to create a combined feed stream; introducing the combined feed stream into a supercritical upgrading reactor operating at a temperature greater than a critical temperature of water and a pressure greater than a critical pressure of water; at least partially converting the combined feed stream to an upgraded product; passing the upgraded product out of the supercritical upgrading reactor to a flash drum; separating the upgraded product in the flash drum to produce a light fraction and a heavy fraction; passing the light fraction to a gas/oil/water separator; separating the light fraction in the gas/oil/water separator to produce a gas fraction, a liquid oil fraction, and a first water fraction; passing the diluted heavy fraction from the flash drum to a demulsifier mixer to form a demulsified heavy fraction; and combining the heavy fraction with at least a portion of the light oil to form a diluted demulsified heavy fraction.

Although the concepts of the present disclosure are portrayed with primary reference to boilers, gas turbines, compressor units, combustor units and the like, it is contemplated that the concepts will enjoy applicability to systems having any configuration or methodology.

### BRIEF DESCRIPTION OF THE DRAWINGS

The following detailed description of specific embodiments of the present disclosure can be best understood when read in conjunction with the following drawings, in which:

FIG. 1 is a schematic view of a process for upgrading a hydrocarbon-based composition, according to the present embodiments;

FIG. 2 is a schematic view of a process for upgrading a hydrocarbon-based composition, according to the present embodiments;

FIG. 3 is a schematic view of a process for upgrading a hydrocarbon-based composition, according to the present embodiments;

FIG. 4 is a schematic view of a process for upgrading a hydrocarbon-based composition, according to the present embodiments; and

FIG. 5 is a schematic view of a process for upgrading a hydrocarbon-based composition, according to the present embodiments.

### DETAILED DESCRIPTION

Embodiments of the present disclosure are directed to processes for separating an upgraded hydrocarbon-based product from a water product in a supercritical water process.

As used throughout the disclosure, “supercritical” refers to a substance at or above a pressure and a temperature greater than or equal to that of its critical pressure and temperature, such that distinct phases do not exist and the substance may exhibit the fast diffusion of a gas while dissolving materials like a liquid. As such, supercritical water is water having a temperature and pressure greater than or equal to the critical temperature and the critical pressure of water. At a temperature and pressure greater than or equal to the critical temperature and pressure, the liquid and gas phase boundary of water disappears, and the fluid has characteristics of both liquid and gaseous substances. Supercritical water is able to dissolve organic compounds like an organic solvent and has excellent diffusibility like a gas. Regulation of the temperature and pressure allows for continuous “tuning” of the properties of the supercritical water to be more liquid-like or more gas-like. Supercritical water has reduced density and lesser polarity, as compared to liquid-phase sub-critical water, thereby greatly extending the possible range of chemistry that can be carried out in water.

As used throughout the disclosure, “upgrade” means to increase the American Petroleum Institute (API) gravity, decrease the amount of impurities, such as sulfur, nitrogen, and metals, decrease the amount of asphaltene, and increase the amount of the light fraction.

Supercritical water has various unexpected properties as it reaches supercritical boundaries. Supercritical water has very high solubility toward organic compounds and has an infinite miscibility with gases. Furthermore, radical species can be stabilized by supercritical water through the cage effect (that is, a condition whereby one or more water molecules surrounds the radical species, which then prevents the radical species from interacting). Without being limited to theory, stabilization of radical species helps prevent inter-radical condensation and thereby reduces the overall coke production in the current embodiments. For example, coke production can be the result of the inter-radical condensation. In certain embodiments, supercritical water generates hydrogen gas through a steam reforming reaction and water-gas shift reaction, which is then available for the upgrading reactions.

Moreover, the high temperature and high pressure of supercritical water may give water a density of 0.123 grams per milliliter (g/mL) at 27 MPa and 450° C. Contrastingly, if the pressure was reduced to produce superheated steam, for example, at 20 MPa and 450° C., the steam would have a density of only 0.079 g/mL. At that density, the hydrocarbons may interact with superheated steam to evaporate and mix into the vapor phase, leaving behind a heavy fraction that may generate coke upon heating. The formation of coke or coke precursor may plug the lines and must be removed. Therefore, supercritical water is superior to steam in some applications.

Specific embodiments will now be described with references to the figures. Whenever possible, the same reference numerals will be used throughout the drawings to refer to the same or like parts.

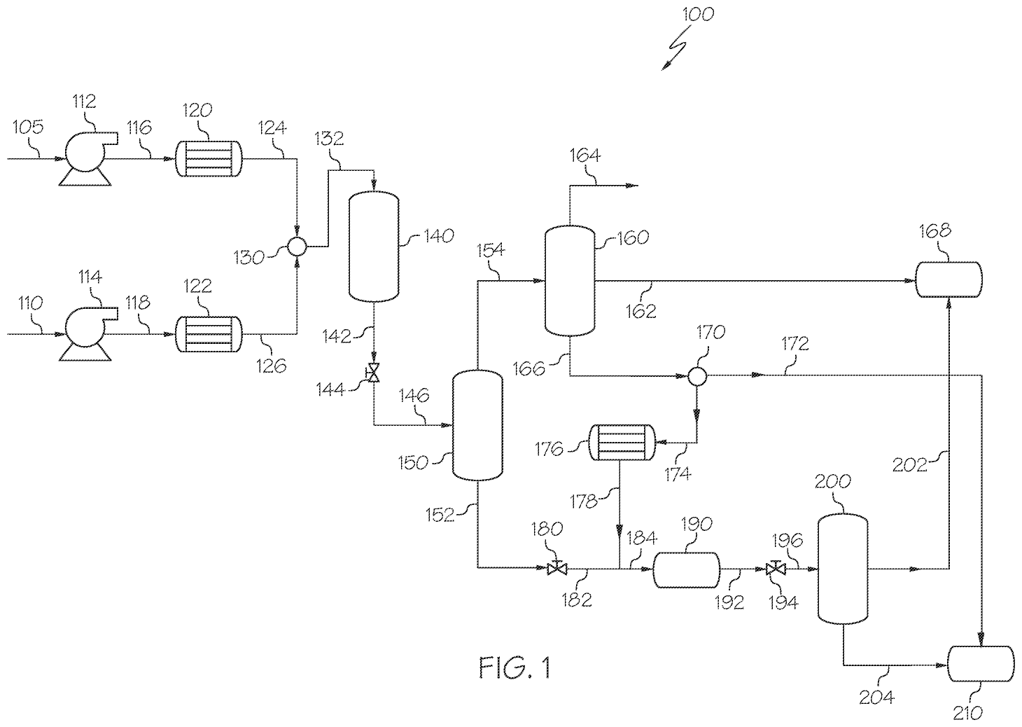

FIGS. 1-5 schematically depict various processes 100 for upgrading a hydrocarbon-based composition 105 that is upgraded in a supercritical upgrading reactor 140, according to embodiments described.

The hydrocarbon-based composition 105 may refer to any hydrocarbon source derived from petroleum, coal liquid, or biomaterials. Possible sources for hydrocarbon-based composition 105 may include crude oil, distilled crude oil, reduced crude oil, residue oil, topped crude oil, product streams from oil refineries, product streams from steam cracking processes, liquefied coals, liquid products recovered from oil or tar sands, bitumen, oil shale, asphaltene, biomass hydrocarbons, and the like. Many compositions are suitable for the hydrocarbon-based composition 105. In some embodiments, the hydrocarbon-based composition 105 may comprise heavy crude oil or a fraction of heavy crude oil. In other embodiments, the hydrocarbon-based composition 105 may include atmospheric residue (AR), atmospheric distillates, vacuum gas oil (VGO), vacuum distillates, or vacuum residue (VR), or cracked product (such as light cycle oil or coker gas oil). In some embodiments, the hydrocarbon-based composition 105 may be combined streams from a refinery, produced oil, or other hydrocarbon streams, such as from an upstream operation. The hydrocarbon-based composition 105 may be decanted oil, oil containing 10 or more carbons (C10+oil), or hydrocarbon streams from an ethylene plant. The hydrocarbon-based composition 105 may, in some embodiments, be liquefied coal or biomaterial-derivatives, such as bio fuel oil. In some embodiments, used lubrication (lube) oil or brake fluids may be used.

The hydrocarbon-based composition 105 may, in some embodiments, be naphtha or kerosene or diesel fractions. Such fractions may be used but may not be upgraded as significantly by the supercritical water and thus may not be desired. Contaminated hydrocarbon fractions may also be used. In some embodiments, fractions with saltwater contamination may be used as the hydrocarbon-based composition 105. For instance, crude oil in market typically has a salt content below about 10 PTB (pounds of salt per 1000 barrels of oil). The salt in saltwater may be precipitated by the supercritical water to produce a desalted product, which may be desirable in some embodiments.

As shown in FIGS. 1-5, a hydrocarbon-based composition 105 may be pressurized in hydrocarbon pump 112 to create a pressurized hydrocarbon-based composition 116. The pressure of pressurized hydrocarbon-based composition 116 may be at least 22.1 megapascals (MPa), which is approximately the critical pressure of water. Alternatively, the pressure of the pressurized hydrocarbon-based composition 116 may be between 23 MPa and 35 MPa, or between 24 MPa and 30 MPa. For instance, the pressure of the pressurized hydrocarbon-based composition 116 may be between 25 MPa and 29 MPa, 26 MPa and 28 MPa, 25 MPa and 30 MPa, 26 MPa and 29 MPa, or 24 MPa and 28 MPa.

Referring still to any of FIGS. 1-5, the pressurized hydrocarbon-based composition 116 may then be heated in one or more hydrocarbon pre-heaters 120 to form pressurized, heated hydrocarbon-based composition 124. In one embodiment, the pressurized, heated hydrocarbon-based composition 124 has a pressure greater than the critical pressure of water and a temperature greater than 75° C. Alternatively, the temperature of the pressurized, heated hydrocarbon-based composition 124 is between 10° C. and 300° C., or between 50° C. and 250° C., or between 75° C. and 225° C., or between 100° C. and 200° C., or between 125° C. and 175° C., or between 140° C. and 160° C. The pressurized, heated hydrocarbon-based composition 124 should not be heated above about 350° C., and in some embodiments, above 300° C. to avoid the formation of coking products. See Hozuma, U.S. Pat. No. 4,243,633, which is incorporated by reference in its entirety. While some coke or coke precursor products may be able to pass through process lines without slowing or stopping the process 100, the formation of these potentially problematic compounds should be avoided if possible.

Embodiments of the hydrocarbon pre-heater 120 may include a natural gas fired heater, heat exchanger, or an electric heater or any type of heater known in the art. In some embodiments, not shown, the pressurized, heated hydrocarbon-based composition 124 may be heated in a double pipe heat exchanger. For example, and not by way of limitation, the double pipe heat exchanger may heat the pressurized, heated hydrocarbon-based composition 124 after it has combined with a supercritical water stream 126 to form a combined feed stream 130.

As shown in FIGS. 1-5, the water stream 110 may be any source of water, such as a water stream having conductivity of less than 1 microSiemens (μS)/centimeters (cm), such as less than 0.1 μS/cm. The water streams 110 may also include demineralized water, distilled water, boiler feed water (BFW), and deionized water. In at least one embodiment, water stream 110 is a boiler feed water stream. Water stream 110 is pressurized by water pump 114 to produce pressurized water stream 118. The pressure of the pressurized water stream 118 is at least 22.1 MPa, which is approximately the critical pressure of water. Alternatively, the pressure of the pressurized water stream 118 may be between 23 MPa and 35 MPa, or between 24 MPa and 30 MPa. For instance, the pressure of the pressurized water stream 118 may be between 25 MPa and 29 MPa, 26 MPa and 28 MPa, 25 MPa and 30 MPa, 26 MPa and 29 MPa, or 24 MPa and 28 MPa.

The pressurized water stream 118 may then be heated in a water pre-heater 122 to create a supercritical water stream 126. The temperature of the supercritical water stream 126 is greater than 374° C., which is approximately the critical temperature of water. Alternatively, the temperature of the supercritical water stream 126 may be greater than 380° C., such as between 380° C. and 600° C., or between 400° C. and 550° C., or between 400° C. and 500° C., or between 400° C. and 450° C., or between 450° C. and 500° C. In some embodiments, the maximum temperature of the supercritical water stream 126 may be 600° C., as the mechanical parts in the water preheater and supercritical reactor system may be affected by temperatures greater than 600° C. In embodiments, the supercritical water stream 126 has low metal content and low conductivity, such as less than 1 microSiemens.

Similar to hydrocarbon pre-heater 120, suitable water pre-heaters 122 may include a natural gas fired heater, a heat exchanger, and an electric heater. The water pre-heater 122 may be a unit separate and independent from the hydrocarbon pre-heater 120.

The supercritical water stream 126 and the pressurized, heated hydrocarbon-based composition 124 may then be mixed in a feed mixer 130 to produce a combined feed stream 132. The feed mixer 130 can be any type of mixing device capable of mixing the supercritical water stream 126 and the pressurized, heated hydrocarbon-based composition 124. In one embodiment, the feed mixer 130 may be a mixing tee. The feed mixer 130 may be an ultrasonic device, a small continuous stir tank reactor (CSTR), or any suitable mixer. The volumetric flow ratio of supercritical water to hydrocarbons fed to the feed mixer 130 may vary. In one embodiment, the volumetric flow ratio may be from 10:1 to 1:10, or 5:1 to 1:5, 1:1 to 4:1 at standard ambient temperature and pressure (SATP).

The combined feed stream 132 may then be introduced to the supercritical upgrading reactor 140 configured to upgrade the combined feed stream 132. The supercritical upgrading reactor 140 may be an upflow, downflow, or horizontal flow reactor. An upflow, downflow or horizontal reactor refers to the direction the supercritical water and hydrocarbon-based composition flow through the supercritical upgrading reactor 140. An upflow, downflow, or horizontal flow reactor may be chosen based on the desired application and system configuration. Without intending to be bound by any theory, in downflow supercritical reactors, heavy hydrocarbon fractions may flow very quickly due to having a greater density, which may result in shortened residence times (known as channeling). This may hinder upgrading, as there is less time for reactions to occur. Upflow supercritical reactors have a uniform increased residence time distribution (no channeling), but may experience difficulties due to undissolved portion of heavy fraction and large particles, such as carbon-containing compounds in the heavy fractions, accumulating in the bottom of the reactor. This accumulation may hinder the upgrading process and plug the reactor. Upflow reactors typically utilize catalysts to provide increased contact with the reactants; however, the catalysts may break down due to the harsh conditions of supercritical water, forming insoluble aggregates, which may generate coke. Horizontal reactors may be useful in applications that desire phase separation or that seek to reduce pressure drop, however; the control of hydrodynamics of internal fluid is difficult. Each type of reactor flow has positive and negative attributes that vary based on the applicable process; however, in some embodiments, an upflow or downflow reactor may be favored.

The combined feed stream 132 may be introduced through an inlet port of the supercritical upgrading reactor 140. The supercritical upgrading reactor 140 may operate at a temperature greater than the critical temperature of water and a pressure greater than the critical pressure of water. In one or more embodiments, the supercritical upgrading reactor 140 may have a temperature of between 380° C. to 480° C., or between 390° C. to 450° C. The supercritical upgrading reactor 140 may be an isothermal or non-isothermal reactor. The reactor may be a tubular-type vertical reactor, a tubular-type horizontal reactor, a vessel-type reactor, a tank-type reactor having an internal mixing device, such as an agitator, or a combination of any of these reactors. Moreover, additional components, such as a stirring rod or agitation device may also be included in the supercritical upgrading reactor 140.

The supercritical upgrading reactor 140 may have dimensions defined by the equation L/D, where L is a length of the supercritical upgrading reactor 140 and D is the diameter of the supercritical upgrading reactor 140. In one or more embodiments, the L/D value of the supercritical upgrading reactor 140 may be sufficient to achieve a superficial velocity of fluid greater than 0.5 meter (m)/minute (min), or an L/D value sufficient to achieve a superficial velocity of fluid between 1 m/min and 5 m/min. Such relatively high fluid velocity is desired to attain full turbulence of the internal fluid. The desired Reynolds number (a measurement of fluid flow) is greater than 5000.

In some embodiments, the residence time of the internal fluid in the supercritical upgrading reactor 140 may be longer than 5 seconds, such as longer than 1 minute. In some embodiments, the residence time of the internal fluid in the supercritical upgrading reactor 140 may be between 2 and 30 minutes, such as between 2 and 20 minutes, or between 5 and 15 minutes, or between 5 and 10 minutes.

Upon exiting the reactor, the pressure of the upgraded product 142 of the supercritical upgrading reactor 140 may be reduced to create a cooled upgraded product 146, which may have a pressure from 0.05 MPa to 2.2 MPa. The depressurizing can be achieved by many devices, for example, a valve 144 as shown in FIGS. 1-5. Optionally, the upgraded product 142 may be cooled to a temperature less than critical point of water (374° C.), such as from 200° C. to 300° C., from 200° C. to 250° C., or from 250° C. to 300° C. in a cooler (not shown) upstream of the valve 144. Various cooling devices are contemplated for the cooler, such as a heat exchanger.

Referring still to any of FIGS. 1-5, the cooled upgraded product 146 may then be fed to flash drum 150 to separate the cooled upgraded product 146 into a heavy fraction 152 and a light fraction 154. In some embodiments, the light fraction 154 and the heavy fraction 152 may be liquid-containing fractions where the hydrocarbons in the light fraction 154 have an API gravity value that is greater than those in the heavy fraction 152. API gravity is a measure of how heavy or light petroleum liquid is when compared to water based on the density relative to water (also known as specific gravity). API gravity can be calculated in accordance with Equation 1 as follows:

$$API Gravity = \frac{141.5}{( Specific Gravity at 60 ° F . ) - 131.5} \qquad EQUATION 1$$

API gravity is a dimensionless quantity that is referred to by degrees, with most petroleum liquids falling between 10° and 70°. In some embodiments, the hydrocarbons in the light fraction 154 may have an API gravity value of greater than or equal to 30°. The hydrocarbons in the light fraction 154 may have an API gravity value from 30° to 40°, 30° to 45°, or from 30° to 50°, or from 30° to 70°. In some embodiments, the hydrocarbons in the light fraction 154 may have an API value of greater than or equal to 31°, such as 31.1°. In some embodiments, the hydrocarbons in the light fraction 154 may have an API value of from 40° to 45°, which may be very commercially desirable. In some embodiments, it may be desirable that the hydrocarbons in the light fraction 154 have an API value of less than 45°.

The hydrocarbons in the heavy fraction 152 may have an API gravity value of less than or equal to 30°. For instance, the hydrocarbons in the heavy fraction 152 may have an API gravity value of less than 30° and greater than or equal to 1°. In some embodiments, the hydrocarbons in the heavy fraction 152 may have an API value from 1° to 20°, from 2° to 20°, from 4° to 20°, from 6° to 20°, from 8° to 20°, from 10° to 20°, from 15° to 20°, from 1° to 15°, from 2° to 15°, from 4° to 15°, from 6° to 15°, from 8° to 15°, from 10° to 15°, from 1° to 10°, from 2° to 10°, from 4° to 10°, from 6° to 10°, from 8° to 10°, from 1° to 8°, from 2° to 8°, from 4° to 8°, from 6° to 8°, from 1° to 6°, from 2° to 6°, from 4° to 6°, from 1° to 4°, or from 2° to 4°. The hydrocarbons in the heavy fraction 152 may have an API gravity value of less than or equal to 20°, less than or equal to 15°, or less than or equal to 10°.

The heavy fraction 152 may have a temperature of from 40° C. to 300° C., from 40° C. to 200° C., from 40° C. to 150° C., from 40° C. to 120° C., from 40° C. to 80° C., from 40° C. to 50° C., from 50° C. to 300° C., from 50° C. to 200° C., from 50° C. to 150° C., from 50° C. to 120° C., from 50° C. to 80° C., from 80° C. to 300° C., from 80° C. to 200° C., from 80° C. to 150° C., from 80° C. to 120° C., from 120° C. to 300° C., from 120° C. to 200° C., from 120° C. to 150° C., from 150° C. to 300° C., from 150° C. to 200° C., or from 200° C. to 300° C.

In some embodiments, the hydrocarbons in the light fraction 154 may have a T₅ true boiling point (TBP), referring to when at least 5% of the fraction has evaporated, of less than or equal to 350° C. In embodiments, gas phase products having boiling point lower than 5° C. at ambient pressure are removed from the light fraction stream 154, before measuring TBP. This ensures that the TBP doesn't include such light gases (even if quantities are very small). These gases include CO, CO₂, H₂S, C₁, C₂, C₃, and C₄. For instance, the hydrocarbons in the light fraction 154 may have a T₅ TBP of less than or equal to 340° C., less than or equal to 330° C., less than or equal to 300° C., less than or equal to 250° C., less than or equal to 200° C., less than or equal to 150° C., less than or equal to 100° C., less than or equal to 75° C., less than or equal to 60° C., less than or equal to 50° C., less than or equal to 40° C., less than or equal to 35° C., less than or equal to 30° C., or less than or equal to 25° C. In some embodiments, the hydrocarbons in the light fraction 154 may have a T₅ TBP of less than or equal to 150° C., such as less than or equal to 125° C., less than or equal to 75° C., or less than or equal to 50° C. The hydrocarbons in the light fraction 154 may have a T₉₀ TBP, referring to when at least 90% of the fraction has evaporated, of less than or equal to 450° C., or less than or equal to 440° C., or less than or equal to 435° C., or less than or equal to 430° C., or less than or equal to 425° C.

In embodiments, the light fraction 154 may include from 50 to 100 wt. %, from 70 to 100 wt. %, from 80 to 100 wt. %, from 85 to 100 wt. %, from 90 to 100 wt. %, from 95 to 100 wt. %, from 99 to 100 wt. %, from 50 to 99 wt. %, from 70 to 99 wt. %, from 80 to 99 wt. %, from 85 to 99 wt. %, from 90 to 99 wt. %, from 95 to 99 wt. %, from 50 to 95 wt. %, from 70 to 95 wt. %, from 80 to 95 wt. %, from 85 to 95 wt. %, from 90 to 95 wt. %, from 50 to 90 wt. %, from 70 to 90 wt. %, from 80 to 90 wt. %, from 85 to 90 wt. %, from 50 to 85 wt. %, from 70 to 85 wt. %, or from 80 to 85 wt. % water.

In some embodiments, the hydrocarbons in the heavy fraction 152 may have a T5 TBP of greater than or equal to 80° C., such as from 80° C. to 120° C. The hydrocarbons in the heavy fraction 152 may have a T5 TBP of greater than or equal to 130° C., or greater than or equal to 140° C., or less than or equal to 560° C. The hydrocarbons in the heavy fraction 152 may have a T90 TBP, of less than or equal to 900° C., such as less than or equal to 890° C., or less than or equal to 885° C., or less than or equal to 875° C.

In embodiments, the heavy fraction 152 may include from 0 to 50 wt %, from 0 to 30 wt. %, from 0 to 20 wt. %, from 0 to 15 wt. %, from 0 to 10 wt. %, from 0 to 5 wt. %, from 0 to 1 wt. %, from 1 to 50 wt %, from 1 to 30 wt. %, from 1 to 20 wt. %, from 1 to 15 wt. %, from 1 to 10 wt. %, from 1 to 5 wt. %, from 5 to 50 wt %, from 5 to 30 wt. %, from 5 to 20 wt. %, from 5 to 15 wt. %, from 5 to 10 wt. %, from 10 to 50 wt %, from 10 to 30 wt. %, from 10 to 20 wt. %, from 10 to 15 wt. %, from 15 to 50 wt %, from 15 to 30 wt. %, or from 15 to 20 wt. % water.

Referring still to any of FIGS. 1-5, the light fraction 154 may be passed to a gas/oil/water separator 160. The gas/oil/water separator 160 may separate the light fraction 154 into a gas fraction 164, a liquid oil fraction 162, and a first water fraction 166. The gas/oil/water separator 160 may be any separator known in the industry. While the gas/oil/water separator 160 may separate the light fraction into at least a gas fraction 164, a liquid oil fraction 162, and a first water fraction 166, it should be appreciated that additional fractions may also be produced.

The liquid oil fraction 162 may have a T₅ TBP of less than or equal to 340° C., less than or equal to 330° C., less than or equal to 300° C., less than or equal to 250° C., less than or equal to 200° C., less than or equal to 150° C., less than or equal to 100° C., less than or equal to 75° C., less than or equal to 60° C., less than or equal to 50° C., less than or equal to 40° C., less than or equal to 35° C., less than or equal to 30° C., or less than or equal to 25° C. In some embodiments, the liquid oil fraction 162 may have a T₅ TBP of less than or equal to 150° C., such as less than or equal to 125° C., less than or equal to 75° C., or less than or equal to 50° C. The liquid oil fraction 162 may have a T₉₀ TBP, referring to when at least 90% of the fraction has evaporated, of less than or equal to 450° C., or less than or equal to 440° C., or less than or equal to 435° C., or less than or equal to 430° C., or less than or equal to 425° C.

In embodiments, the liquid oil fraction 162 may include from 0 to 0.3 wt. %, from 0 to 0.1 wt. %, or 0 wt. % water.

In embodiments, the first water fraction 166 may include from 99 to 100 wt. %, from 99 to 99.9 wt. %, from 99 to 99.7 wt. %, from 99.7 to 100 wt. %, from 99.7 to 99.9 wt. %, from 99.9 to 100 wt. %, or 100 wt. % water.

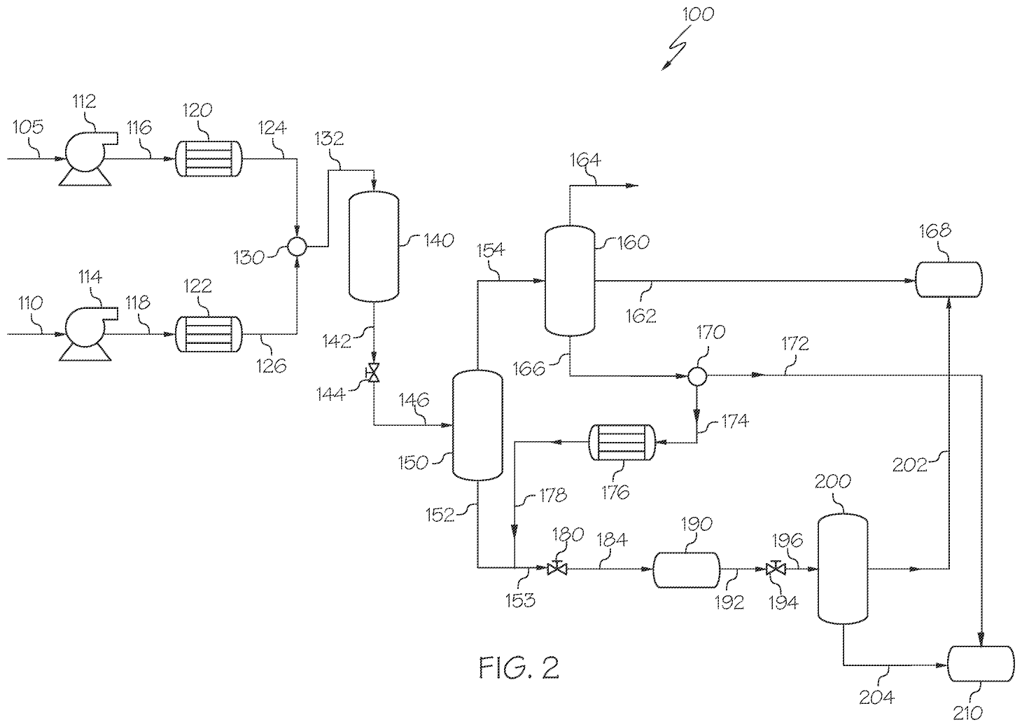

Referring now to FIGS. 1-2, in embodiments, the liquid oil fraction 162 may be passed to an oil storage tank 168, and the first water fraction 166 may be split via a water flow splitter 170 into a water product 172 and a water cutterstock 174. The first water fraction 166 may be split such that the water product 172 comprises from 5 vol. % to 95 vol. %, from 10 vol. % to 95 vol. %, from 20 vol. % to 95 vol. %, from 30 vol. % to 95 vol. %, from 40 vol. % to 95 vol. %, from 50 vol. % to 90 vol. %, from 50 vol. % to 80 vol. %, from 50 vol. % to 75 vol. %, from 50 vol. % to 70 vol. %, from 50 vol. % to 60 vol. %, from 60 vol. % to 90 vol. %, from 60 vol. % to 80 vol. %, from 60 vol. % to 75 vol. %, from 60 vol. % to 70 vol. %, from 70 vol. % to 90 vol. %, from 70 vol. % to 80 vol. %, from 70 vol. % to 75 vol. %, from 75 vol. % to 90 vol. %, from 75 vol. % to 80 vol. %, or from 80 vol. % to 90 vol. % of the first water fraction 166. In each of the previously described instances, the water cutterstock 174 comprises the remainder of the volume of the first water fraction 166 split via the water flow splitter 170. For example, the water cutterstock 174 may comprise from 5 vol. % to 95 vol. %, from 5 vol. % to 90 vol. %, from 5 vol. % to 80 vol. %, from 5 vol. % to 70 vol. %, from 5 vol. % to 60 vol. %, from 5 vol. % to 50 vol. %, from 10 vol. % to 50 vol. %, from 10 vol. % to 40 vol. %, from 10 vol. % to 30 vol. %, from 10 vol. % to 25 vol. %, from 10 vol. % to 20 vol. %, from 20 vol. % to 50 vol. %, from 20 vol. % to 40 vol. %, from 20 vol. % to 30 vol. %, from 20 vol. % to 25 vol. %, from 25 vol. % to 50 vol. %, from 25 vol. % to 40 vol. %, from 25 vol. % to 30 vol. %, from 30 vol. % to 50 vol. %, from 30 vol. % to 40 vol. %, or from 40 vol. % to 50 vol. % of the first water fraction 166. In embodiments, the flow rate of the water cutterstock 174 is less than the flow rate of the water product 172. The water flow splitter 170 may be any known splitting device able to separate the first water fraction 166 into at least two streams as shown. As shown in FIGS. 1-2, in embodiments, the water product 172 may be passed to a water storage tank 210. The water cutterstock 174 may be sent to a water heater 176 to form a heated water cutterstock 178. The water heater 176 may include a natural gas fired heater, heat exchanger, an electric heater, or any type of heater known in the art.

Referring now to FIG. 2, in embodiments, the heated water cutterstock 178 may then be combined with the heavy fraction 152. Specifically, the heated water cutterstock 178 combines with the heavy fraction 152 to form the first combined stream 153. In embodiments, the heated water cutterstock 178 may combine with the heavy fraction 152 via a mixer (not shown). The mixer may be any suitable mixer known in the art, such as a simple mixing tee, ultrasonic device, a small continuous stir tank reactor (CSTR), or another known mixer.

In embodiments, the first combined stream 153 may include from 0 to 50 wt. %, from 0 to 30 wt. %, from 0 to 20 wt. %, from 0 to 15 wt. %, from 0 to 10 wt. %, from 0 to 5 wt. %, from 0 to 1 wt. %, from 1 to 50 wt. %, from 1 to 30 wt. %, from 1 to 20 wt. %, from 1 to 15 wt. %, from 1 to 10 wt. %, from 1 to 5 wt. %, from 5 to 50 wt. %, from 5 to 30 wt. %, from 5 to 20 wt. %, from 5 to 15 wt. %, from 5 to 10 wt. %, from 10 to 50 wt. %, from 10 to 30 wt. %, from 10 to 20 wt. %, from 10 to 15 wt. %, from 15 to 50 wt. %, from 15 to 30 wt. %, or from 15 to 20 wt. % water. It is contemplated that the increase in water content may decrease the viscosity of the stream, thereby improving the mobility of the first combined stream 153 as compared to the heavy fraction 152.

The first combined stream 153 is then depressurized via heavy fraction valve 180 to form the first depressurized combined stream 184. The pressure of the first depressurized combined stream 184 is controlled by the demulsifier mixer valve 194. The pressure of the first depressurized combined stream 184 may be greater than the saturation pressure of water at the temperature of the first depressurized combined stream 184 and the first demulsified heavy fraction 192.

In embodiments, the first depressurized combined stream 184 may include from 0 to 50 wt %, from 0 to 30 wt. %, from 0 to 20 wt. %, from 0 to 15 wt. %, from 0 to 10 wt. %, from 0 to 5 wt. %, from 0 to 1 wt. %, from 1 to 50 wt %, from 1 to 30 wt. %, from 1 to 20 wt. %, from 1 to 15 wt. %, from 1 to 10 wt. %, from 1 to 5 wt. %, from 5 to 50 wt %, from 5 to 30 wt. %, from 5 to 20 wt. %, from 5 to 15 wt. %, from 5 to 10 wt. %, from 10 to 50 wt %, from 10 to 30 wt. %, from 10 to 20 wt. %, from 10 to 15 wt. %, from 15 to 50 wt %, from 15 to 30 wt. %, or from 15 to 20 wt. % water.

Alternatively, referring back to FIG. 1, in embodiments, the heavy fraction 152 may first be depressurized via the heavy fraction valve 180 to form a depressurized heavy fraction 182 before combining with the heated water cutterstock 178. In such embodiments, the heated water cutterstock 178 may combine with the depressurized heavy fraction 182 to form the first depressurized combined stream 184, as shown in FIG. 1. In embodiments, the heated water cutterstock 178 may combine with the depressurized heavy fraction 182 via a mixer (not shown), as previously described.

Referring again to FIGS. 1-2, the first depressurized combined stream 184 may then be passed to a demulsifier mixer 190 to form the first demulsified heavy fraction 192. The first depressurized combined stream 184 may have a flow rate of from 0.2 to 0.35 liters per hour (L/hr), from 0.2 to 0.3 L/hr, from 0.2 to 0.25 L/hr, from 0.25 to 0.35 L/hr, from 0.25 to 0.3 L/hr, or from 0.3 to 0.35 L/hr. In embodiments, the demulsifier mixer 190 may include a CSTR having an internal agitator. In embodiments, the temperature of the demulsifier mixer 190 may be from 50° C. to 300° C., from 90° C. to 250° C., from 110° C. to 200° C., or from 150° C. to 175° C. Without intending to be bound by theory, a temperature of 190° C. may provide sufficient energy for water droplets in the fluid emulsion to form larger droplets. The size of the dispersed water droplets in the oil medium affects the rate at which the water droplets move and attach to each other through the oil medium. Larger water droplets tend to coalescence easier and faster due to similar density, polarity, hydrogen bonding, and van der Waals interactions, thereby allowing for easier separation of the emulsion phases. The pressure of the demulsifier mixer 190 may be higher than the saturation pressure of water at the temperature of the demulsifier mixer 190 to keep water in liquid phase. In embodiments, the demulsifying agent may be injected into the demulsifier mixer 190 from 0.001 vol. % to 1.5 vol. %, from 0.01 vol. % to 0.5 vol. %, or about 0.1 vol. % of volumetric flow rate of the first depressurized combined stream 184. Without intending to be bound by theory, it may be beneficial to have a relatively lower demulsifying agent injection rate at least because the demulsifying agent may introduce additional impurities into the first demulsified heavy fraction 192. In embodiments, the demulsifying agent may include amine compounds, polyhydric alcohols, polyethylene oxides, glycols, or combinations thereof.

In embodiments, the first demulsified heavy fraction 192 may be depressurized via demulsifier mixer valve 194 to form the first depressurized demulsified heavy fraction 196. The first demulsified heavy fraction 192 may have a pressure of from 0.01 MPa to 0.05 MPa, from 0.01 MPa to 0.04 MPa, from 0.01 MPa to 0.03 MPa, from 0.01 MPa to 0.02 MPa, from 0.02 MPa to 0.05 MPa, from 0.02 MPa to 0.04 MPa, from 0.02 MPa to 0.03 MPa, from 0.03 MPa to 0.05 MPa, from 0.03 MPa to 0.04 MPa, or from 0.04 MPa to 0.05 MPa. The first depressurized demulsified heavy fraction 196 has a pressure of from 0.01 MPa to 0.05 MPa, from 0.01 MPa to 0.04 MPa, from 0.01 MPa to 0.03 MPa, from 0.01 MPa to 0.02 MPa, from 0.02 MPa to 0.05 MPa, from 0.02 MPa to 0.04 MPa, from 0.02 MPa to 0.03 MPa, from 0.03 MPa to 0.05 MPa, from 0.03 MPa to 0.04 MPa, or from 0.04 MPa to 0.05 MPa. Although the first demulsified heavy fraction 192 and the first depressurized heavy fraction 196 have a similar range of pressure, the pressure of the first depressurized heavy fraction 196 is less than the pressure of the first demulsified heavy fraction 192, due to the depressurization via demulsifier mixer valve 194. This ensures the pressure drop between the first demulsified heavy fraction 192 and the first depressurized heavy fraction 196, which ensures flow. The first depressurized demulsified heavy fraction 196 may then be sent to an oil/water separator 200 to separate the first depressurized demulsified heavy fraction 196 into the first heavy oil fraction 202 and the second water fraction 204. The oil/water separator 200 may be any separator known in the industry. The first heavy oil fraction 202 may be passed to the oil storage tank 168. The second water fraction 204 may then be passed to the water storage tank 210. In embodiments, the second water fraction 204 may include may include from 99 to 100 wt. %, from 99 to 99.9 wt. %, from 99 to 99.7 wt. %, from 99.7 to 100 wt. %, from 99.7 to 99.9 wt. %, from 99.9 to 100 wt. %, or 100 wt. % water.

The hydrocarbons in the first depressurized heavy fraction 196 may have an API gravity value of less than or equal to 30°. For instance, the hydrocarbons in the first depressurized heavy fraction 196 may have an API gravity value of less than 30° and greater than or equal to 1°. In some embodiments, the hydrocarbons in the first depressurized heavy fraction 196 may have an API value from 1° to 20°, from 2° to 20°, from 4° to 20°, from 6° to 20°, from 8° to 20°, from 10° to 20°, from 15° to 20°, from 1° to 15°, from 2° to 15°, from 4° to 15°, from 6° to 15°, from 8° to 15°, from 10° to 15°, from 1° to 10°, from 2° to 10°, from 4° to 10°, from 6° to 10°, from 8° to 10°, from 1° to 8°, from 2° to 8°, from 4° to 8°, from 6° to 8°, from 1° to 6°, from 2° to 6°, from 4° to 6°, from 1° to 4°, or from 2° to 4°. The hydrocarbons in the first depressurized heavy fraction 196 may have an API gravity value of less than or equal to 20°, less than or equal to 15°, or less than or equal to 10°.

In some embodiments, the hydrocarbons in the first depressurized heavy fraction 196 may have a T5 TBP of greater than or equal to 80° C., such as from 80° C. to 120° C. The hydrocarbons in the first depressurized heavy fraction 196 may have a T5 TBP of greater than or equal to 130° C., or greater than or equal to 140° C., or less than or equal to 560° C. The hydrocarbons in the first depressurized heavy fraction 196 may have a T90 TBP, of less than or equal to 900° C., such as less than or equal to 890° C., or less than or equal to 885° C., or less than or equal to 875° C.

The hydrocarbons in the first heavy oil fraction 202 may have an API gravity value of less than or equal to 30°. For instance, the hydrocarbons in the first the first heavy oil fraction 202 may have an API gravity value of less than 30° and greater than or equal to 1°. In some embodiments, the hydrocarbons in the first the first heavy oil fraction 202 may have an API value from 1° to 20°, from 2° to 20°, from 4° to 20°, from 6° to 20°, from 8° to 20°, from 10° to 20°, from 15° to 20°, from 1° to 15°, from 2° to 15°, from 4° to 15°, from 6° to 15°, from 8° to 15°, from 10° to 15°, from 1° to 10°, from 2° to 10°, from 4° to 10°, from 6° to 10°, from 8° to 10°, from 1° to 8°, from 2° to 8°, from 4° to 8°, from 6° to 8°, from 1° to 6°, from 2° to 6°, from 4° to 6°, from 1° to 4°, or from 2° to 4°. The hydrocarbons in the first the first heavy oil fraction 202 may have an API gravity value of less than or equal to 20°, less than or equal to 15°, or less than or equal to 10°.

In some embodiments, the hydrocarbons in the first heavy oil fraction 202 may have a T5 TBP of greater than or equal to 80° C., such as from 80° C. to 120° C. The hydrocarbons in the first heavy oil fraction 202 may have a T5 TBP of greater than or equal to 130° C., or greater than or equal to 140° C., or less than or equal to 560° C. The hydrocarbons in the first heavy oil fraction 202 may have a T90 TBP, of less than or equal to 900° C., such as less than or equal to 890° C., or less than or equal to 885° C., or less than or equal to 875° C.

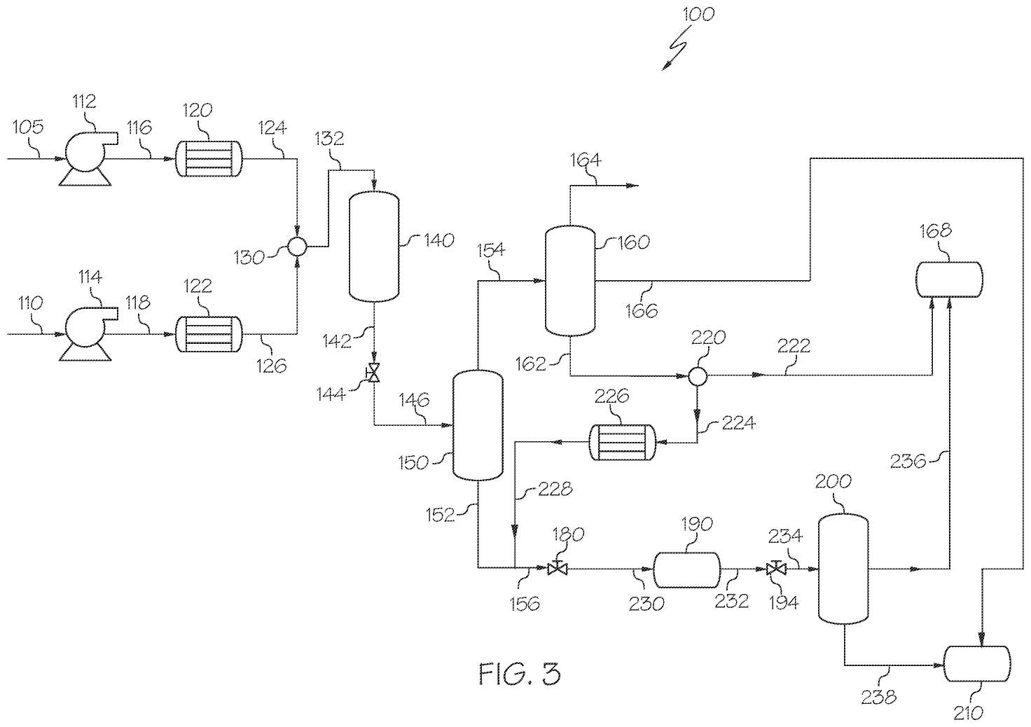

Additionally or alternatively, referring now to FIGS. 3-5, in embodiments, the first water fraction 166 may be passed to the water storage tank 210, and the liquid oil fraction 162 may be split via a flow splitter 220 into a liquid oil product 222 and a liquid oil cutterstock 224. The liquid oil fraction 162 may be split such that the liquid oil product 222 comprises from 50 vol. % to 90 vol. %, from 50 vol. % to 80 vol. %, from 50 vol. % to 75 vol. %, from 50 vol. % to 70 vol. %, from 50 vol. % to 60 vol. %, from 60 vol. % to 90 vol. %, from 60 vol. % to 80 vol. %, from 60 vol. % to 75 vol. %, from 60 vol. % to 70 vol. %, from 70 vol. % to 90 vol. %, from 70 vol. % to 80 vol. %, from 70 vol. % to 75 vol. %, from 75 vol. % to 90 vol. %, from 75 vol. % to 80 vol. %, or from 80 vol. % to 90 vol. % of the liquid oil fraction 162. In each of the previously described instances, the liquid oil cutterstock 224 comprises the remainder of the volume of the liquid oil fraction 162 split via the flow splitter 220. For example, the liquid oil cutterstock 224 may comprise from 10 vol. % to 50 vol. %, from 10 vol. % to 40 vol. %, from 10 vol. % to 30 vol. %, from 10 vol. % to 25 vol. %, from 10 vol. % to 20 vol. %, from 20 vol. % to 50 vol. %, from 20 vol. % to 40 vol. %, from 20 vol. % to 30 vol. %, from 20 vol. % to 25 vol. %, from 25 vol. % to 50 vol. %, from 25 vol. % to 40 vol. %, from 25 vol. % to 30 vol. %, from 30 vol. % to 50 vol. %, from 30 vol. % to 40 vol. %, or from 40 vol. % to 50 vol. % of the liquid oil fraction 162. The flow splitter 220 may be any known splitting device able to separate the liquid oil fraction 162 into at least two steams as shown. In embodiments, the liquid oil product 222 may be passed to the oil storage tank 168. The liquid oil cutterstock 224 may be sent to an oil heater 226 to form a heated liquid oil cutterstock 228. The heated liquid oil cutterstock 228 may have a temperature of from 40° C. to 300° C., from 40° C. to 200° C., from 40° C. to 150° C., from 40° C. to 120° C., from 40° C. to 80° C., from 40° C. to 50° C., from 50° C. to 300° C., from 50° C. to 200° C., from 50° C. to 150° C., from 50° C. to 120° C., from 50° C. to 80° C., from 80° C. to 300° C., from 80° C. to 200° C., from 80° C. to 150° C., from 80° C. to 120° C., from 120° C. to 300° C., from 120° C. to 200° C., from 120° C. to 150° C., from 150° C. to 300° C., from 150° C. to 200° C., or from 200° C. to 300° C. The oil heater 226 may include a natural gas fired heater, heat exchanger, an electric heater, or any type of heater known in the art.

The heated liquid oil cutterstock 228 may be combined with the heavy fraction 152 at various points of the downstream process, as shown in each of FIGS. 3-5. Referring now to FIG. 3, in embodiments, the heated liquid oil cutterstock 228 may then be passed to combine with the heavy fraction 152. Specifically, the heated oil cutterstock 228 combines with the heavy fraction 152 to form a second combined stream 156. In embodiments, the heated liquid oil cutterstock 228 may combine with the heavy fraction 152 via a mixer (not shown). The mixer may be any suitable mixer known in the art, such as a simple mixing tee, ultrasonic device, a small CSTR, or another known mixer. The second combined stream 156 is then depressurized via heavy fraction valve 180 to form the second depressurized combined stream 230. The pressure of the second depressurized combined stream 230 may be greater than the saturation pressure of water at the temperature of the second depressurized combined stream 230.

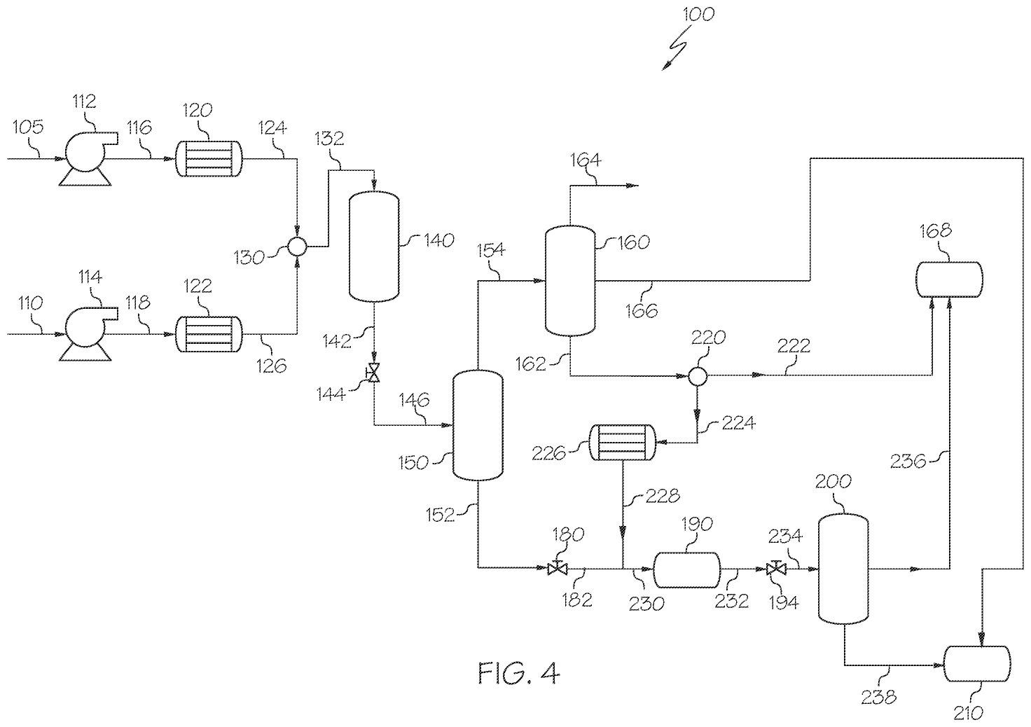

Alternatively, referring to FIG. 4, in embodiments, the heavy fraction 152 may first be depressurized via the heavy fraction valve 180 to form the depressurized heavy fraction 182 before combining with the heated liquid oil cutterstock 228. In such embodiments, the heated liquid oil cutterstock 228 may combine with the depressurized heavy fraction 182 to form the second depressurized combined stream 230, as shown in FIG. 4. In embodiments, the heated liquid oil cutterstock 228 may combine with the depressurized heavy fraction 182 via a mixer (not shown), as previously described.

Referring to FIGS. 3-4, the second depressurized combined stream 230 may then be passed to demulsifier mixer 190 to form a second demulsified heavy fraction 232. The demulsifier mixer 190 may be as previously described.

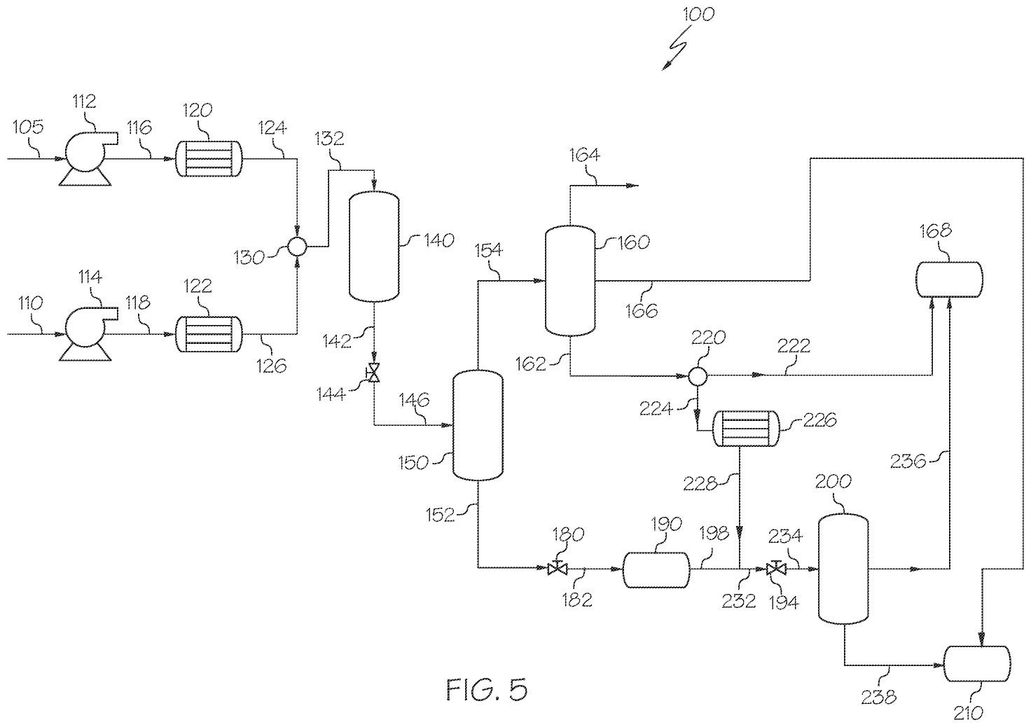

Alternatively, referring to FIG. 5, in embodiments, the depressurized heavy fraction 182 may first be passed to the demulsifier mixer 190 to form a third demulsified heavy fraction 198 before combining with the heated liquid oil cutterstock 228. In such embodiments, the heated liquid oil cutterstock 228 may combine with the third demulsified heavy fraction 198 to form the second demulsified heavy fraction 232, as shown in FIG. 5. In embodiments, the heated liquid oil cutterstock 228 may combine with the demulsified heavy fraction 232 via a mixer (not shown), as previously described.

Referring to FIGS. 3-5, in embodiments, the second demulsified heavy fraction 232 may be depressurized via demulsifier mixer valve 194 to form a second depressurized demulsified heavy fraction 234. The second depressurized demulsified heavy fraction 234 may have a pressure of from 0.01 MPa to 0.05 MPa, from 0.01 MPa to 0.04 MPa, from 0.01 MPa to 0.03 MPa, from 0.01 MPa to 0.02 MPa, from 0.02 MPa to 0.05 MPa, from 0.02 MPa to 0.04 MPa, from 0.02 MPa to 0.03 MPa, from 0.03 MPa to 0.05 MPa, from 0.03 MPa to 0.04 MPa, or from 0.04 MPa to 0.05 MPa. The second depressurized demulsified heavy fraction 234 may then be sent to the oil/water separator 200 to separate the second depressurized demulsified heavy fraction 234 into a second heavy oil fraction 236 and a third water fraction 238. The oil/water separator 200 may be any separator known in the industry. The second heavy oil fraction 236 may be passed to the oil storage tank 168. The third water fraction 238 may then be passed to the water storage tank 210.

The hydrocarbons in the second heavy oil fraction 236 may have an API gravity value of less than or equal to 30°. For instance, the hydrocarbons in the second heavy oil fraction 236 may have an API gravity value of less than 30° and greater than or equal to 1°. In some embodiments, the hydrocarbons in the second heavy oil fraction 236 may have an API value from 1° to 20°, from 2° to 20°, from 4° to 20°, from 6° to 20°, from 8° to 20°, from 10° to 20°, from 15° to 20°, from 1° to 15°, from 2° to 15°, from 4° to 15°, from 6° to 15°, from 8° to 15°, from 10° to 15°, from 1° to 10°, from 2° to 10°, from 4° to 10°, from 6° to 10°, from 8° to 10°, from 1° to 8°, from 2° to 8°, from 4° to 8°, from 6° to 8°, from 1° to 6°, from 2° to 6°, from 4° to 6°, from 1° to 4°, or from 2° to 4°. The hydrocarbons in the second heavy oil fraction 236 may have an API gravity value of less than or equal to 20°, less than or equal to 15°, or less than or equal to 10°.

In some embodiments, the hydrocarbons in the second heavy oil fraction 236 may have a T5 TBP of greater than or equal to 80° C., such as from 80° C. to 120° C. The hydrocarbons in the second heavy oil fraction 236 may have a T5 TBP of greater than or equal to 130° C., or greater than or equal to 140° C., or less than or equal to 560° C. The hydrocarbons in second heavy oil fraction 236 may have a T90 TBP, of less than or equal to 900° C., such as less than or equal to 890° C., or less than or equal to 885° C., or less than or equal to 875° C.

In embodiments, the oil product stored within the oil storage tank 168 may include the liquid oil fraction 162 and the first heavy oil fraction 202, or the liquid oil product 222 and the second heavy oil fraction 236. In embodiments, the oil product stored within the oil storage tank 168 may have a T₅ TBP of from 100° C. to 250° C., from 100° C. to 215° C., from 100° C. to 214° C., from 100° C. to 210° C., from 100° C. to 200° C., from 100° C. to 195° C., from 100° C. to 190° C., from 100° C. to 185° C., from 120° C. to 250° C., from 120° C. to 215° C., from 120° C. to 214° C., from 120° C. to 210° C., from 120° C. to 200° C., from 120° C. to 195° C., from 120° C. to 190° C., from 120° C. to 185° C., from 150° C. to 250° C., from 150° C. to 215° C., from 150° C. to 214° C., from 150° C. to 210° C., from 150° C. to 200° C., from 150° C. to 195° C., from 150° C. to 190° C., from 150° C. to 185° C., from 160° C. to 250° C., from 160° C. to 215° C., from 160° C. to 214° C., from 160° C. to 210° C., from 160° C. to 200° C., from 160° C. to 195° C., from 160° C. to 190° C., from 160° C. to 185° C., from 165° C. to 250° C., from 165° C. to 215° C., from 165° C. to 214° C., from 165° C. to 210° C., from 165° C. to 200° C., from 165° C. to 195° C., from 165° C. to 190° C., from 165° C. to 185° C., from 170° C. to 250° C., from 170° C. to 215° C., from 170° C. to 214° C., from 170° C. to 210° C., from 170° C. to 200° C., from 170° C. to 195° C., from 170° C. to 190° C., from 170° C. to 185° C., from 175° C. to 250° C., from 175° C. to 215° C., from 175° C. to 214° C., from 175° C. to 210° C., from 175° C. to 200° C., from 175° C. to 195° C., from 175° C. to 190° C., from 175° C. to 185° C., or of approximately 180° C.

In embodiments, the oil product stored within the oil storage tank 168 may have a T₁₀ TBP of from 150° C. to 250° C., from 150° C. to 230° C., from 150° C. to 229° C., from 150° C. to 225° C., from 150° C. to 220° C., from 150° C. to 215° C., from 150° C. to 210° C., from 170° C. to 250° C., from 170° C. to 230° C., from 170° C. to 229° C., from 170° C. to 225° C., from 170° C. to 220° C., from 170° C. to 215° C., from 170° C. to 210° C., from 185° C. to 250° C., from 185° C. to 230° C., from 185° C. to 229° C., from 185° C. to 225° C., from 185° C. to 220° C., from 185° C. to 215° C., from 185° C. to 210° C., from 190° C. to 250° C., from 190° C. to 230° C., from 190° C. to 229° C., from 190° C. to 225° C., from 190° C. to 220° C., from 190° C. to 215° C., from 190° C. to 210° C., from 200° C. to 250° C., from 200° C. to 230° C., from 200° C. to 229° C., from 200° C. to 225° C., from 200° C. to 220° C., from 200° C. to 215° C., from 200° C. to 210° C., from 205° C. to 250° C., from 205° C. to 230° C., from 205° C. to 229° C., from 205° C. to 225° C., from 205° C. to 220° C., from 205° C. to 215° C., from 205° C. to 210° C., or of approximately 208° C.

In embodiments, the oil product stored within the oil storage tank 168 may have a T₃₀ TBP of from 210° C. to 350° C., from 210° C. to 320° C., from 210° C. to 301° C., from 210° C. to 300° C., from 210° C. to 295° C., from 210° C. to 290° C., from 230° C. to 350° C., from 230° C. to 320° C., from 230° C. to 301° C., from 230° C. to 300° C., from 230° C. to 295° C., from 230° C. to 290° C., from 260° C. to 350° C., from 260° C. to 320° C., from 260° C. to 301° C., from 260° C. to 300° C., from 260° C. to 295° C., from 260° C. to 290° C., from 270° C. to 350° C., from 270° C. to 320° C., from 270° C. to 301° C., from 270° C. to 300° C., from 270° C. to 295° C., from 270° C. to 290° C., from 275° C. to 350° C., from 275° C. to 320° C., from 275° C. to 301° C., from 275° C. to 300° C., from 275° C. to 295° C., from 275° C. to 290° C., from 280° C. to 350° C., from 280° C. to 320° C., from 280° C. to 301° C., from 280° C. to 300° C., from 280° C. to 295° C., from 280° C. to 290° C., from 285° C. to 350° C., from 285° C. to 320° C., from 285° C. to 301° C., from 285° C. to 300° C., from 285° C. to 295° C., from 285° C. to 290° C., or of approximately 287° C.

In embodiments, the oil product stored within the oil storage tank 168 may have a T₅₀ TBP of from 300° C. to 550° C., from 300° C. to 520° C., from 300° C. to 513° C., from 300° C. to 512° C., from 300° C. to 510° C., from 300° C. to 505° C., from 300° C. to 500° C., from 300° C. to 495° C., from 350° C. to 550° C., from 350° C. to 520° C., from 350° C. to 513° C., from 350° C. to 512° C., from 350° C. to 510° C., from 350° C. to 505° C., from 350° C. to 500° C., from 350° C. to 495° C., from 400° C. to 550° C., from 400° C. to 520° C., from 400° C. to 513° C., from 400° C. to 512° C., from 400° C. to 510° C., from 400° C. to 505° C., from 400° C. to 500° C., from 400° C. to 495° C., from 425° C. to 550° C., from 425° C. to 520° C., from 425° C. to 513° C., from 425° C. to 512° C., from 425° C. to 510° C., from 425° C. to 505° C., from 425° C. to 500° C., from 425° C. to 495° C., from 450° C. to 550° C., from 450° C. to 520° C., from 450° C. to 513° C., from 450° C. to 512° C., from 450° C. to 510° C., from 450° C. to 505° C., from 450° C. to 500° C., from 450° C. to 495° C., from 470° C. to 550° C., from 470° C. to 520° C., from 470° C. to 513° C., from 470° C. to 512° C., from 470° C. to 510° C., from 470° C. to 505° C., from 470° C. to 500° C., from 470° C. to 495° C., from 475° C. to 550° C., from 475° C. to 520° C., from 475° C. to 513° C., from 475° C. to 512° C., from 475° C. to 510° C., from 475° C. to 505° C., from 475° C. to 500° C., from 475° C. to 495° C., from 480° C. to 550° C., from 480° C. to 520° C., from 480° C. to 513° C., from 480° C. to 512° C., from 480° C. to 510° C., from 480° C. to 505° C., from 480° C. to 500° C., from 480° C. to 495° C., from 485° C. to 550° C., from 485° C. to 520° C., from 485° C. to 513° C., from 485° C. to 512° C., from 485° C. to 510° C., from 485° C. to 505° C., from 485° C. to 500° C., from 485° C. to 495° C., from 490° C. to 550° C., from 490° C. to 520° C., from 490° C. to 513° C., from 490° C. to 512° C., from 490° C. to 510° C., from 490° C. to 505° C., from 490° C. to 500° C., from 490° C. to 495° C., or of approximately 494° C.

In embodiments, the oil product stored within the oil storage tank 168 may have a T₇₀ TBP of from 495° C. to 650° C., from 495° C. to 620° C., from 495° C. to 609° C., from 495° C. to 608° C., from 495° C. to 605° C., from 500° C. to 650° C., from 500° C. to 620° C., from 500° C. to 609° C., from 500° C. to 608° C., from 500° C. to 605° C., from 525° C. to 650° C., from 525° C. to 620° C., from 525° C. to 609° C., from 525° C. to 608° C., from 525° C. to 605° C., from 550° C. to 650° C., from 550° C. to 620° C., from 550° C. to 609° C., from 550° C. to 608° C., from 550° C. to 605° C., from 575° C. to 650° C., from 575° C. to 620° C., from 575° C. to 609° C., from 575° C. to 608° C., from 575° C. to 605° C., from 580° C. to 650° C., from 580° C. to 620° C., from 580° C. to 609° C., from 580° C. to 608° C., from 580° C. to 605° C., from 585° C. to 650° C., from 585° C. to 620° C., from 585° C. to 609° C., from 585° C. to 608° C., from 585° C. to 605° C., from 590° C. to 650° C., from 590° C. to 620° C., from 590° C. to 609° C., from 590° C. to 608° C., from 590° C. to 605° C., from 595° C. to 650° C., from 595° C. to 620° C., from 595° C. to 609° C., from 595° C. to 608° C., from 595° C. to 605° C., from 600° C. to 650° C., from 600° C. to 620° C., from 600° C. to 609° C., from 600° C. to 608° C., from 600° C. to 605° C., or of approximately 601° C.

### EXAMPLES

The following simulation examples illustrate one or more embodiments of the present disclosure previously discussed. Specifically, simulations were carried out in accordance with the previously described embodiments, particularly with respect to the embodiments of the processes depicted in FIGS. 1-5. Additionally, a comparative example simulation was conducted. In the tables below, the term “depressurized” is shortened to “depress.” for convenience.

The Examples below include simulations of processes as described in this application. In the Examples below, the feed water was demineralized and had a conductivity of 0.056 microSiemens per centimeter (μS/cm). The feedstock oil had a volumetric flow rate at standard ambient temperature and pressure (SATP) of 0.5 L/hr. The feed water had a volumetric flow rate at SATP of 1.0 L/hr. The feedstock oil and feed water were preheated to 150° C. and 480° C., respectively, using separated electric heaters. The feed mixer was a tee fitting having inner diameter of 1.6 millimeters. The reactor consisted of two tubular reactors in series, first one in upflow and second one in downflow. The volume of each reactor was about 160 mL (an internal diameter of 20.2 mm and a length of 500 mm). The reactors were surrounded by electric heaters. The temperature of both reactors were set to 430° C. (the temperature of internal fluid in the exit). The upgraded product from the reactor was cooled by a double-pipe type heat exchanger where cooling water flows in outer shell to form cooled upgraded product 146. Then, the following schemes and conditions were applied to the cooled upgraded product 146:

### Example 1

A simulation was carried out in accordance with FIG. 1. The separation conditions for the process are listed in Table 1, which are listed both by name and by the reference number used in FIG. 1.

TABLE 1
Process Conditions

| | | Cooled | | Depress. | | | First |
|---|---|---|---|---|---|---|---|
| | Upgraded | Upgraded | Light | Light | Liquid Oil | Gas | Water |
| Name | Product | Product | Fraction | Fraction | Fraction | Fraction | Fraction |
| FIG. Ref. No. | 142 | 146 | 154 | 154 | 162 | 164 | 166 |
| Temperature | 250 to 350 | 120 to 300 | 120 to 300 | 120 to 300 | 25 to 75 | 25 to 75 | 25 to 75 |
| [° C.] | | | | | | | |
| Pressure | 23 to 27 | 0.1 to 5 | 0.1 to 5 | 0.01 to 0.5 | 0.01 to 0.5 | 0.01 to 0.5 | 0.01 to 0.5 |
| [MPa] | | | | | | | |

| | | | | | | First |
|---|---|---|---|---|---|---|
| | | | Heated | | Depress. | Depress. |
| | Water | Water | Water | Heavy | Heavy | Combined |
| Name | Product | Cutterstock | Cutterstock | Fraction | Fraction | Stream |
| FIG. Ref. No. | 172 | 174 | 178 | 152 | 182 | 184 |
| Temperature | 25 to 75 | 25 to 75 | 25 to 75 | 120 to 300 | 50 to 150 | 50 to 150 |
| [° C.] | | | | | | |
| Pressure | 0.01 to 0.5 | 0.01 to 0.5 | 0.01 to 0.5 | 0.1 to 5 | 0.01 to 0.5 | 0.01 to 0.5 |
| [MPa] | | | | | | |

| | First | First Depress. | | |
|---|---|---|---|---|
| | Demulsified | Demulsified | Second | First |
| | Heavy | Heavy | Water | Heavy Oil |
| Name | Fraction | Fraction | Fraction | Fraction |
| FIG. Ref. No. | 192 | 196 | 204 | 202 |
| Temperature | 50 to 150 | 50 to 150 | 25 to 75 | 50 to 150 |
| [° C.] | | | | |
| Pressure | 0.01 to 0.5 | 0.01 to 0.5 | 0.01 to 0.5 | 0.01 to 0.5 |
| [MPa] | | | | |

### Example 2

A simulation was carried out in accordance with FIG. 2. The separation conditions for the process are listed in Table 2, which are listed both by name and by the reference number used in FIG. 2.

TABLE 2
Reaction Conditions

| | | Cooled | | Depress. | | | First |
|---|---|---|---|---|---|---|---|
| | Upgraded | Upgraded | Light | Light | Liquid Oil | Gas | Water |
| Name | Product | Product | Fraction | Fraction | Fraction | Fraction | Fraction |
| FIG. Ref. No. | 142 | 146 | 154 | 154 | 162 | 164 | 166 |
| Temperature | 250 to 350 | 120 to 300 | 120 to 300 | 120 to 300 | 25 to 75 | 25 to 75 | 25 to 75 |
| [° C.] | | | | | | | |
| Pressure | 23 to 27 | 0.1 to 5 | 0.1 to 5 | 0.01 to 0.5 | 0.01 to 0.5 | 0.01 to 0.5 | 0.01 to 0.5 |
| [MPa] | | | | | | | |

| | | | | | | First |
|---|---|---|---|---|---|---|
| | | | Heated | | First | Depress. |
| | Water | Water | Water | Heavy | Combined | Combined |
| Name | Product | Cutterstock | Cutterstock | Fraction | Stream | Stream |
| FIG. Ref. No. | 172 | 174 | 178 | 152 | 153 | 184 |
| Temperature | 25 to 75 | 25 to 75 | 25 to 75 | 120 to 300 | 120 to 300 | 50 to 150 |
| [° C.] | | | | | | |
| Pressure | 0.01 to 0.5 | 0.01 to 0.5 | 0.01 to 0.5 | 0.1 to 5 | 0.1 to 5 | 0.01 to 0.5 |
| [MPa] | | | | | | |

| | First | First Depress. | | |
|---|---|---|---|---|
| | Demulsified | Demulsified | Second | First |
| | Heavy | Heavy | Water | Heavy Oil |
| Name | Fraction | Fraction | Fraction | Fraction |
| FIG. Ref. No. | 192 | 196 | 204 | 202 |
| Temperature | 50 to 150 | 50 to 150 | 25 to 75 | 50 to 150 |
| [° C.] | | | | |
| Pressure | 0.01 to 0.5 | 0.01 to 0.5 | 0.01 to 0.5 | 0.01 to 0.5 |
| [MPa] | | | | |

### Example 3

A simulation was carried out in accordance with FIG. 3. The separation conditions for the process are listed in Table 3, which are listed both by name and by the reference number used in FIG. 3.

TABLE 3
Reaction Conditions

| | | Cooled | | Depress. | | | First |
|---|---|---|---|---|---|---|---|
| | Upgraded | Upgraded | Light | Light | Liquid Oil | Gas | Water |
| Name | Product | Product | Fraction | Fraction | Fraction | Fraction | Fraction |
| FIG. Ref. No. | 142 | 146 | 154 | 154 | 162 | 164 | 166 |
| Temperature | 250 to 350 | 120 to 300 | 120 to 300 | 120 to 300 | 25 to 75 | 25 to 75 | 25 to 75 |
| [° C.] | | | | | | | |
| Pressure | 23 to 27 | 0.1 to 5 | 0.1 to 5 | 0.01 to 0.5 | 0.01 to 0.5 | 0.01 to 0.5 | 0.01 to 0.5 |
| [MPa] | | | | | | | |

| | | | | | | Second |
|---|---|---|---|---|---|---|
| | | | Heated | | Second | Depress. |
| | Liquid Oil | Liquid Oil | Liquid Oil | Heavy | Combined | Combined |
| Name | Product | Cutterstock | Cutterstock | Fraction | Stream | Stream |
| FIG. Ref. No. | 222 | 224 | 228 | 152 | 156 | 230 |
| Temperature | 25 to 75 | 25 to 75 | 50 to 150 | 50 to 150 | 50 to 150 | 50 to 150 |
| [° C.] | | | | | | |
| Pressure | 0.01 to 0.5 | 0.01 to 0.5 | 0.01 to 0.5 | 0.01 to 0.5 | 0.01 to 0.5 | 0.01 to 0.5 |
| [MPa] | | | | | | |

| | | Second | | |
|---|---|---|---|---|
| | Second | Depress. | | |
| | Demulsified | Demulsified | | Second |
| | Heavy | Heavy | Third Water | Heavy Oil |
| Name | Fraction | Fraction | Fraction | Fraction |
| FIG. Ref. No. | 232 | 234 | 238 | 236 |
| Temperature | 50 to 150 | 50 to 150 | 25 to 75 | 50 to 150 |
| [° C.] | | | | |
| Pressure | 0.01 to 0.5 | 0.01 to 0.5 | 0.01 to 0.5 | 0.01 to 0.5 |
| [MPa] | | | | |

### Example 4

A simulation was carried out in accordance with FIG. 4. The separation conditions for the process are listed in Table 4, which are listed both by name and by the reference number used in FIG. 4.

TABLE 4
Reaction Conditions

| | | Cooled | | Depress. | | | First |
|---|---|---|---|---|---|---|---|
| | Upgraded | Upgraded | Light | Light | Liquid Oil | Gas | Water |
| Name | Product | Product | Fraction | Fraction | Fraction | Fraction | Fraction |
| FIG. Ref. No. | 142 | 146 | 154 | 154 | 162 | 164 | 166 |
| Temperature | 250 to 350 | 120 to 300 | 120 to 300 | 120 to 300 | 25 to 75 | 25 to 75 | 25 to 75 |
| [° C.] | | | | | | | |
| Pressure | 23 to 27 | 0.1 to 5 | 0.1 to 5 | 0.01 to 0.5 | 0.01 to 0.5 | 0.01 to 0.5 | 0.01 to 0.5 |
| [MPa] | | | | | | | |

| | | | | | | Second |
|---|---|---|---|---|---|---|
| | | | Heated | | Depress. | Depress. |
| | Liquid Oil | Liquid Oil | Liquid Oil | Heavy | Heavy | Combined |
| Name | Product | Cutterstock | Cutterstock | Fraction | Fraction | Stream |
| FIG. Ref. No. | 222 | 224 | 228 | 152 | 182 | 230 |
| Temperature | 25 to 75 | 25 to 75 | 50 to 150 | 50 to 150 | 50 to 150 | 50 to 150 |
| [° C.] | | | | | | |
| Pressure | 0.01 to 0.5 | 0.01 to 0.5 | 0.01 to 0.5 | 0.01 to 0.5 | 0.01 to 0.5 | 0.01 to 0.5 |
| [MPa] | | | | | | |

| | | Second | | |
|---|---|---|---|---|
| | Second | Depress. | | |
| | Demulsified | Demulsified | | Second |
| | Heavy | Heavy | Third Water | Heavy Oil |
| Name | Fraction | Fraction | Fraction | Fraction |
| FIG. Ref. No. | 232 | 234 | 238 | 236 |
| Temperature | 50 to 150 | 50 to 150 | 50 to 150 | 50 to 150 |
| [° C.] | | | | |
| Pressure | 0.01 to 0.5 | 0.01 to 0.5 | 0.01 to 0.5 | 0.01 to 0.5 |
| [MPa] | | | | |

### Example 5

A simulation was carried out in accordance with FIG. 5. The separation conditions for the process are listed in Table 5, which are listed both by name and by the reference number used in FIG. 5.

TABLE 5
Reaction Conditions

| | | Cooled | | Depress. | | | First |
|---|---|---|---|---|---|---|---|
| | Upgraded | Upgraded | Light | Light | Liquid Oil | Gas | Water |
| Name | Product | Product | Fraction | Fraction | Fraction | Fraction | Fraction |
| FIG. Ref. No. | 142 | 146 | 154 | 154 | 162 | 164 | 166 |
| Temperature | 250 to 350 | 120 to 300 | 120 to 300 | 120 to 300 | 25 to 75 | 25 to 75 | 25 to 75 |
| [° C.] | | | | | | | |
| Pressure | 23 to 27 | 0.1 to 5 | 0.1 to 5 | 0.01 to 0.5 | 0.01 to 0.5 | 0.01 to 0.5 | 0.01 to 0.5 |
| [MPa] | | | | | | | |

| | | | | | | Third |
|---|---|---|---|---|---|---|
| | | | Heated | | Depress. | Demulsified |
| | Liquid Oil | Liquid Oil | Liquid Oil | Heavy | Heavy | Heavy |
| Name | Product | Cutterstock | Cutterstock | Fraction | Fraction | Fraction |
| FIG. Ref. No. | 222 | 224 | 228 | 152 | 182 | 198 |
| Temperature | 25 to 75 | 25 to 75 | 50 to 150 | 50 to 150 | 50 to 150 | 50 to 150 |
| [° C.] | | | | | | |
| Pressure | 0.01 to 0.5 | 0.01 to 0.5 | 0.01 to 0.5 | 0.01 to 0.5 | 0.01 to 0.5 | 0.01 to 0.5 |
| [MPa] | | | | | | |

| | | Second | | |
|---|---|---|---|---|
| | Second | Depress. | | |
| | Demulsified | Demulsified | | Second |
| | Heavy | Heavy | Third Water | Heavy Oil |
| Name | Fraction | Fraction | Fraction | Fraction |
| FIG. Ref. No. | 232 | 234 | 238 | 236 |
| Temperature | 50 to 150 | 50 to 150 | 50 to 150 | 50 to 150 |
| [° C.] | | | | |
| Pressure | 0.01 to 0.5 | 0.01 to 0.5 | 0.01 to 0.5 | 0.01 to 0.5 |
| [MPa] | | | | |

In Example 5, upgraded product 142 was cooled to 250° C. and then depressurized to 0.1 MPa to form cooled upgraded product 146, having a temperature of 180° C. Cooled upgraded product 146 was then sent to flash drum 150, which had an external heater so cooled upgraded product 146 maintained a fluid temperature of 180° C. The flash drum 150 had an internal volume of 0.75 liters. Heavy fraction 152 and light fraction 154 were then depressurized to 0.05 MPa. The depressurized light fraction 154 was then cooled to around 30° C. and then sent to a gas/oil/water separator 160 (having a diameter of 0.14 meters, a length of 0.75 meters, and an internal volume of about 10 liters) and separated into liquid oil fraction 162, gas fraction 164, and first water fraction 166. Depressurized heavy fraction 182 was then sent to demulsifier mixer 190 to form the first demulsified heavy fraction 192. The demulsifier mixer was a cascade continuous stirred tank reactor (CSTR) having an internal agitator, where the temperature was maintained at 70° C. A demulsifier mixer (Petrolite RP2241, available from Baker Hughes) was injected to the CSTR at a 2 mL/hour flow rate. Then, separated light oil was injected into the depressurized heavy fraction 198 at a flow rate of 100 mL/hour. Then, the combined stream was depressurized to 0.15 MPa and sent to an oil/water separator 200 (having a diameter of 0.14 meters, a length of 0.75 meters, an internal volume of about 10 liters, and an internal temperature of 70° C.). The combined stream was then separated in the oil/water separator 200 to form an oil product and a water product.

The oil product was analyzed to determine the water content, relying on ASTM D1769. The oil product contained 0.2 wt % water, which met the acceptable downstream operational requirements for hydroprocessing, which require a water content of less than 0.3 wt %. The oil recovered through the oil stream was about 95 wt % of the feedstock oil. The gas stream included about 4 wt % of the feedstock oil. Therefore, about 1 wt % of the feedstock oil was lost to the water stream in Example 1, which outperformed Comparative Example 1, which lost about 4 wt. % of the feedstock oil to the water stream.

### Comparative Example 1

In Comparative Example 1, a simulation was carried out where the process was similar to the processes described herein, until cooled upgraded product 146. In other words, the process mirrored the processes described herein and in the figures until cooled upgraded product 146, but then the processes differed. However, in Comparative Example 1, a feedstock stream mirroring cooled upgraded product 146 as disclosed herein was sent to a demulsifier mixer (instead of a flash drum 150 shown in FIGS. 1-5) to form a demulsified stream, and then to a gas/oil/water separator, where the demulsified stream was separated into at least a gas product, an oil product, and a water product.

In Comparative Example 1, a feedstock stream was cooled to below 100° C. and depressurized to 0.15 MPa. The feedstock stream mirroring cooled upgraded product 146 was then sent to a demulsifier mixer to form a demulsified stream. The demulsifier mixer was a cascade continuous stirred tank reactor (CSTR) having an internal agitator, where the temperature was maintained at 70° C. A demulsifier mixer was injected to the CSTR at a 3 mL/hour flow rate. The demulsified stream was then sent at a flow rate of about 1.5 L/hr to a gas/oil/water separator having a diameter of 0.14 meters, a length of 0.75 meters, and an internal volume of about 10 liters. The top and bottom ports of the flash drum were located at about 0.7 meters from the edge. The demulsified stream was then separated in the flash drum to form a gas product, an oil product, and a water product.

The compositional properties of the feedstock stream and the oil product are listed in Table 6. The properties were measured using ASTM D1796.

TABLE 6
Feedstock and Product Properties

| | | | Oil product in |
|---|---|---|---|
| | Feedstock | Oil Product in | comparative |
| Feed quality | Stream | Examples 1-5 | example |
| API | 10.7 | 20.7 | 20.2 |
| Sulfur, wt % | 4.5 | 4.4 | 4.4 |
| MCR, wt % | 15.5 | 3.2 | 3.2 |
| Asphaltene, wt % | 4.9 | 1.1 | 1.1 |
| Nickel, wtppm | 25 | 3 | 3 |
| Vanadium, wtppm | 75 | 9 | 9 |
| Nitrogen, ppm | 2,772 | 2,300 | 2,200 |
| Viscosity @ | 150 | 10 | 12 |
| 100° C., cSt | | | |

Distillation, ° C. (ASTM D-6352)

| | | | |
|---|---|---|---|
| 5% | 372 | 180 | 215 |
| 10% | 409 | 208 | 230 |
| 30% | 506 | 287 | 301 |
| 50% | 585 | 494 | 513 |
| 70% | 663 | 601 | 609 |

The oil stream was analyzed to determine the water content, relying on ASTM D1769. The oil stream contained 1.6 wt. % water, which is greater than the acceptable downstream operational requirements for hydroprocessing, which require a water content of less than 0.3 wt. %. The oil recovered through the oil stream was about 91 wt % of the feedstock oil. The gas stream included about 4 wt % of the feedstock oil. Therefore, about 5 wt % of the feedstock oil was lost to the water stream in Comparative Example 1. Table 6 exhibits that the oil product in Examples 1-5 includes a greater amount of lighter hydrocarbons at least because the T₅ TBP is 180° C., as compared to the comparative example, which has a T₅ TBP of 215° C. This means that oil products in Examples 1-5 include a greater amount of lighter hydrocarbons, as compared to the comparative example, and therefore the process of Examples 1-5 results in less naphtha loss.

Additionally, when a demulsifier is used upstream from the flash column (as in Comparative Example 1), as opposed to when the flash column used upstream from the demulsifier (as in the embodiments of the present disclosure), part of the light oil fraction will be attached to the water and be separated with the water rich phase in the gas/oil/water separator 160. The light oil fraction is attached to the water by emulsification caused by the presence of alkali metals, vanadium, iron, nickel, etc., in the feed stream, which act as emulsifying agents. This will result in less hydrocarbon recovery, because some of the light oil fraction will be in the water fraction. This means that oil products in Examples 1-5 include a greater amount of lighter hydrocarbons, as compared to the Comparative Example 1, and therefore the process of Examples 1-5 results in less hydrocarbon loss than the Comparative Example 1.

It should be apparent to those skilled in the art that various modifications and variations may be made to the embodiments described within without departing from the spirit and scope of the claimed subject matter. Thus, it is intended that the specification cover the modifications and variations of the various embodiments described within provided such modification and variations come within the scope of the appended claims and their equivalents.

As used throughout the disclosure, the singular forms “a,” “an” and “the” include plural referents unless the context clearly dictates otherwise. Thus, for example, reference to “a” component includes aspects having two or more such components, unless the context clearly indicates otherwise.

Having described the subject matter of the present disclosure in detail and by reference to specific embodiments thereof, it is noted that the various details disclosed within should not be taken to imply that these details relate to elements that are essential components of the various embodiments described within, even in cases where a particular element is illustrated in each of the drawings that accompany the present description. Further, it should be apparent that modifications and variations are possible without departing from the scope of the present disclosure, including, but not limited to, embodiments defined in the appended claims. More specifically, although some aspects of the present disclosure are identified as particularly advantageous, it is contemplated that the present disclosure is not necessarily limited to these aspects.

1. A process for upgrading a hydrocarbon-based composition comprising:
combining a supercritical water stream with a pressurized, heated hydrocarbon-based composition in a mixing device to create a combined feed stream;
introducing the combined feed stream into a supercritical upgrading reactor operating at a temperature greater than a critical temperature of water and a pressure greater than a critical pressure of water;
at least partially converting the combined feed stream to an upgraded product;
passing the upgraded product out of the supercritical upgrading reactor to a flash drum;
separating the upgraded product in the flash drum to produce a light fraction and a heavy fraction;
passing the light fraction to a gas/oil/water separator;
separating the light fraction in the gas/oil/water separator to produce a gas fraction, a liquid oil fraction, and a first water fraction;
combining the heavy fraction with at least a portion of one of the liquid oil fraction or the first water fraction to form a diluted heavy fraction; and
passing the diluted heavy fraction from the flash drum to a demulsifier mixer to form a demulsified heavy fraction.

2. The process of claim 1, wherein combining the heavy fraction with at least a portion of one of the liquid oil fraction or the first water fraction comprises combining the heavy fraction with at least a portion of the first water fraction.

3. The process of claim 1, wherein combining the heavy fraction with at least a portion of one of the liquid oil fraction or the first water fraction comprises combining the heavy fraction with at least a portion of the liquid oil fraction.

4. The process of claim 1, further comprising passing the upgraded product to a cooling device to form a cooled upgraded product after passing the upgraded product out of the supercritical upgrading reactor.

5. The process of claim 4, further comprising passing the cooled upgraded product to a depressurizing device.

6. The process of claim 1, further comprising depressurizing the light fraction before passing the light fraction to the gas/oil/water separator.

7. The process of claim 6, wherein depressurizing the light fraction comprises depressurizing the light fraction to less than 1 MPa.

8. The process of claim 1, further comprising passing the demulsified heavy fraction to an oil/water separator.

9. The process of claim 8, further comprising separating the demulsified heavy fraction in the oil/water separator to produce a heavy oil fraction and a second water fraction.

10. The process of claim 1, further comprising depressurizing the heavy fraction before forming the diluted heavy fraction.

11. The process of claim 10, wherein depressurizing the heavy fraction comprises depressurizing the heavy fraction to less than 1 MPa.

12. The process of claim 1, further comprising depressurizing the diluted heavy fraction before passing the diluted heavy fraction to the demulsifier mixer, wherein depressurizing the heavy fraction comprises depressurizing the heavy fraction to less than 1 MPa.

13. The process of claim 1, further comprising passing at least a portion of the liquid oil fraction to an oil storage tank.

14. The process of claim 1, further comprising passing the demulsified heavy fraction to an oil storage tank.

15. A process for upgrading a hydrocarbon-based composition comprising:
combining a supercritical water stream with a pressurized, heated hydrocarbon-based composition in a mixing device to create a combined feed stream;
introducing the combined feed stream into a supercritical upgrading reactor operating at a temperature greater than a critical temperature of water and a pressure greater than a critical pressure of water;
at least partially converting the combined feed stream to an upgraded product;
passing the upgraded product out of the supercritical upgrading reactor to a flash drum;
separating the upgraded product in the flash drum to produce a light fraction and a heavy fraction;
passing the light fraction to a gas/oil/water separator;
separating the light fraction in the gas/oil/water separator to produce a gas fraction, a liquid oil fraction, and a first water fraction;
passing the heavy fraction from the flash drum to a demulsifier mixer to form a demulsified heavy fraction; and
combining the heavy fraction with at least a portion of the light oil to form a diluted demulsified heavy fraction.

16. The process of claim 15, further comprising passing the diluted demulsified heavy fraction to an oil/water separator.

17. The process of claim 16, further comprising separating the diluted demulsified heavy fraction in the oil/water separator to produce a heavy oil fraction and a second water fraction.

18. The process of claim 15, further comprising depressurizing the light fraction before passing the light fraction to the gas/oil/water separator.

19. The process of claim 18, wherein depressurizing the light fraction comprises depressurizing the light fraction to less than 1 MPa.

20. The process of claim 15, further comprising passing at least a portion of the liquid oil fraction to an oil storage tank and passing the demulsified heavy fraction to an oil storage tank.
